(19) United States
(12) Patent Application Publication
(10) Pub. No.: US 2019/0309692 A1
(43) Pub. Date: Oct. 10, 2019

(54) Valve System And Assembly Including The Same

(71) Applicant: BorgWarner Inc., Auburn Hills, MI (US)

(72) Inventors: David B. Roth, Groton, NY (US); B. Jerry Song, Novi, MI (US); Iago González Tabarés, Pontevedra (ES); Xurxo Perez, Pontevedra (ES); Joseph A. Ciaravino, Huntington Woods, MI (US)

(21) Appl. No.: 15/991,612

(22) Filed: May 29, 2018

Related U.S. Application Data
(60) Provisional application No. 62/654,998, filed on Apr. 9, 2018.

(51) Int. Cl. F02D 13/02; F02M 26/43; F02D 41/00; F01N 13/10; F02M 26/06

(52) U.S. Cl. CPC F02D 13/0276; F02M 26/43; F02D 41/006; F02F 2001/4278; F01N 13/107; F02M 26/06; F02D 41/0055

(57) ABSTRACT

An assembly for controlling a flow of exhaust gas from an engine includes a blowdown manifold and a scavenge manifold adapted to be coupled to the engine for receiving the exhaust gas. The assembly also includes a valve system including a blowdown pipe coupled to the blowdown manifold, a scavenge pipe coupled to the scavenge manifold, a scavenge valve member coupled to the scavenge pipe and disposed within the scavenge passage, and at least one actuator operably coupled to the scavenge valve member. The assembly further includes a turbocharger coupled to the blowdown pipe, with the turbocharger including a turbine housing defining a turbine housing interior. The scavenge valve member of the valve system is disposed outside of the turbine housing interior.

### CROSS-REFERENCE TO RELATED APPLICATIONS

The subject application claims priority to and all benefits of U.S. Provisional Patent Application No. 62/654,998 filed on Apr. 9, 2018, which is incorporated by reference in its entirety.

### BACKGROUND OF THE INVENTION

### 1. Field of the Invention

The present invention relates generally to valve system and an assembly including the same for controlling a flow of exhaust gas from an engine.

### 2. Description of the Related Art

Conventional vehicles include an engine for converting chemical energy from fuel into useful mechanical energy, which causes the engine to emit exhaust gas. To control a flow of the exhaust gas, conventional vehicles include a manifold for receiving exhaust gas from the engine, which then directs the flow of the exhaust gas from the engine through various exhaust control systems before the exhaust gas exits into the atmosphere. In recent years, there has been a desire to both improve the efficiency of engines, and to reduce harmful toxins emitted from engines by improving exhaust control systems.

To help improve the efficiency of engines, many vehicles include a turbocharger to receive the exhaust gas from the engine and to deliver compressed air to the engine. Turbochargers are used to increase power output of the engine, lower fuel consumption of the engine, and reduce emissions produced by the engine. Delivery of compressed air to the engine by the turbocharger allows the engine to be smaller, yet still able to develop the same or similar amount of horsepower as larger, naturally aspirated engines. Having a smaller engine for use in the vehicle reduces the mass and aerodynamic frontal area of the vehicle, which helps reduce fuel consumption of the combustion engine and improve fuel economy of the vehicle.

To help reduce harmful toxins emitted from engines, many vehicles include various pollution control devices, such as a catalytic converter, to help reduce toxins in the exhaust gas from entering the atmosphere. Specifically, the flow of the exhaust gas is directed by a valve system through the various exhaust control systems and through the catalytic converter prior to entering the atmosphere. Catalytic converters are more efficient when warmed up to an operating temperature, which may take anywhere from a few seconds to a few minutes to achieve. To help warm up the catalytic converter to the operating temperature, the relatively hot exhaust gas is selectively controlled between the turbocharger and the catalytic converter by the valve system. During a start-up of the engine, more exhaust gas is delivered to the catalytic converter by bypassing the turbocharger to help warm up the catalytic converter to the operating temperature. After the catalytic converter is at the operating temperature, the exhaust gas is then selectively controlled to flow to the turbocharger when the engine demands more power.

However, typical valve systems are expensive to design, manufacture, and assemble. As such, there remains a need for an improved valve system for controlling the exhaust gas from the engine.

### SUMMARY OF THE INVENTION AND ADVANTAGES

An assembly for controlling a flow of exhaust gas from an engine includes a blowdown manifold adapted to be coupled to the engine for receiving the exhaust gas from the engine, and a scavenge manifold adapted to be coupled to the engine for receiving the exhaust gas from the engine independent from the blowdown manifold. The assembly also includes a valve system including a blowdown pipe coupled to the blowdown manifold, with the blowdown pipe defining a blowdown passage to receive the exhaust gas from the blowdown manifold, and a scavenge pipe coupled to the scavenge manifold, with the scavenge pipe defining a scavenge passage to receive the exhaust gas from the scavenge manifold. The assembly additionally includes a scavenge valve member coupled to the scavenge pipe and disposed within the scavenge passage, with the scavenge valve member being moveable to regulate the flow of exhaust gas through the scavenge passage, and at least one actuator operably coupled to the scavenge valve member, with the at least one actuator being adapted to selectively control movement of the scavenge valve member to regulate the flow of exhaust gas. The assembly further includes a turbocharger coupled to the blowdown pipe, with the turbocharger including a turbine housing defining a turbine housing interior, and a turbine wheel disposed within the turbine housing interior. The scavenge valve member of the valve system is disposed outside of the turbine housing interior.

Accordingly, the assembly including the valve system including the scavenge valve member disposed outside of the turbine housing interior reduces the overall cost of the design, manufacture, and assembly of the valve system.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic illustration of a vehicle including an engine and an assembly for controlling exhaust gas from the engine, with the assembly including a blowdown manifold, a scavenge manifold, a turbocharger including a turbine housing defining a turbine housing interior, and a valve control system, with the valve control system including a blowdown pipe coupled to the blowdown manifold, a scavenge pipe coupled to the scavenge manifold, a scavenge valve member coupled to said scavenge pipe, and at least one actuator, with the scavenge valve member being disposed outside of the turbine housing interior, and with the scavenge valve member being disposed downstream of the scavenge manifold and upstream of the turbocharger;

FIG. 1A is a schematic illustration of the assembly and the valve system, with the valve system further including a blowdown valve member coupled to the blowdown pipe, with the blowdown valve member being disposed downstream of the blowdown manifold and upstream of the turbocharger;

FIG. 1B is a schematic illustration of the assembly and the valve system, with the at least one actuator being further defined as a first actuator and a second actuator, with the first actuator being operably coupled to the scavenge valve member, with the second actuator being operably coupled to the blowdown valve member, and with the valve system including a first valve shaft extending along a first axis and coupled to the scavenge valve member, and a second valve shaft extending along a second axis and coupled to the blowdown valve member, with the first and second valve shafts being parallel to one another;

FIG. 1C is a schematic illustration of the assembly and the valve system, with the turbocharger including a wastegate actuator and a wastegate valve member operably coupled to the wastegate actuator;

FIG. 2 is a schematic illustration of the assembly and the valve system, with the scavenge valve member being disposed downstream of the scavenge manifold and downstream of the turbocharger, and the blowdown valve member being disposed downstream of the blowdown manifold and downstream of the turbocharger;

FIG. 2A is a schematic illustration of the assembly and the valve system, with the scavenge valve member being disposed downstream of the blowdown manifold and downstream of the turbocharger;

FIG. 3 is a schematic illustration of the assembly and the valve system, with the valve system further including a third valve member, with the scavenge valve member being disposed downstream of the scavenge manifold and upstream of the turbocharger, the blowdown valve member being disposed downstream of the blowdown manifold and upstream of the turbocharger, and the third valve member being disposed downstream of the blowdown and scavenge manifolds and upstream of the turbocharger;

FIG. 4 is a schematic illustration of the assembly and the valve system, with the scavenge valve member being disposed downstream of the scavenge manifold and downstream of the turbocharger, the blowdown valve member being dispoded downstream of the blowdown manifold and downstream of the turbocharger, and with the assembly further including the wastegate actuator and wastegate valve;

FIG. 5 is a schematic sectional illustration of the valve system and the turbocharger of the assembly, with the blowdown pipe and the scavenge pipe sharing a common wall separating the blowdown passage from the scavenge passage, with the common wall defining a wastegate crossover passage fluidly coupling the blowdown passage and the scavenge passage, with the scavenge valve member being positioned to allow the flow of the exhaust gas through the scavenge passage in the scavenge pipe, the blowdown valve member being positioned to allow the flow of the exhaust gas through the blowdown passage in the blowdown pipe, and the third valve member is positioned to close the wastegate crossover passage between the blowdown pipe and the scavenge pipe;

FIG. 5A is a schematic sectional illustration of the valve system and the turbocharger of the assembly, with the scavenge valve member being positioned to allow the flow of the exhaust gas through the scavenge passage in the scavenge pipe, the blowdown valve member being positioned to allow the flow of the exhaust gas through the blowdown passage in the blowdown pipe; and the wastegate valve member being disposed within the turbine housing interior;

FIG. 6 is a schematic sectional illustration of the valve system and the turbocharger of the assembly, with the first valve plate being positioned to allow the flow of the exhaust gas through the blowdown passage in the blowdown pipe, the second plate is positioned to allow the flow of the exhaust gas through the scavenge passage in the scavenge pipe, and the third valve member is positioned to open the wastegate crossover passage between the blowdown pipe and the scavenge pipe to allow the flow of the exhaust gas between the blowdown passage and the scavenge passage;

FIG. 6A is a schematic sectional illustration of the valve system and the turbocharger of the assembly, with the scavenge valve plate being positioned to allow the flow of the exhaust gas through the scavenge passage in the scavenge pipe, the blowdown valve member being positioned to allow the flow of the exhaust gas through the blowdown passage in the blowdown pipe, and the wastegate valve member being disposed within the turbine housing interior;

FIG. 7 is a schematic sectional illustration of the valve system and the turbocharger of the assembly, with the blowdown valve member being positioned to allow the flow of the exhaust gas through the blowdown passage in the blowdown pipe, the scavenge valve member being positioned to restrict the flow of the exhaust gas through the scavenge passage in the scavenge pipe, and the third valve member is positioned to close the wastegate crossover passage between the blowdown pipe and the scavenge pipe;

FIG. 7A is a schematic sectional illustration of the valve system and the turbocharger of the assembly, with the blowdown valve member being positioned to allow the flow of the exhaust gas through the blowdown passage in the blowdown pipe, the scavenge valve member is positioned to restrict the flow of the exhaust gas through the scavenge passage in the scavenge pipe, and the wastegate valve member being disposed within the turbine housing interior;

FIG. 8 is a schematic sectional illustration of the valve system and the turbocharger of the assembly, with the blowdown valve member being positioned to restrict the flow of the exhaust gas through the blowdown passage in the blowdown pipe, the scavenge valve member being positioned to allow the flow of the exhaust gas through We scavenge passage in the scavenge pipe, and the third valve member is positioned to close the wastegate crossover passage between the blowdown pipe and the scavenge pipe;

FIG. 8A is a schematic sectional illustration of the valve system and the turbocharger of the assembly, with the blowdown valve member being positioned to restrict the flow of the exhaust gas through the blowdown passage in the blowdown pipe, the scavenge valve member is positioned to allow the flow of the exhaust gas through the scavenge passage in the scavenge pipe, and the wastegate valve member being disposed within the turbine housing interior;

FIG. 9 is a schematic sectional illustration of the valve system and the turbine housing of the turbocharger of the assembly, with the blowdown valve member being disposed downstream of the blowdown manifold and upstream of the turbocharger, the scavenge valve member being disposed downstream of the scavenge manifold and upstream of the turbocharger, and the third valve member being disposed downstream of the blowdown and scavenge manifolds and upstream of the turbocharger, and with the scavenge, blowdown, and third valve members being disposed outside of the turbine housing interior;

FIG. 10 is a schematic sectional illustration of the valve system and the turbine housing of the turbocharger of the assembly, with the blowdown valve member being disposed downstream of the blowdown manifold and downstream of the turbocharger, and the scavenge valve member being disposed downstream of the scavenge manifold and downstream of the turbocharger, and with the scavenge and blowdown valve members being disposed outside of the turbine housing interior;

FIG. 11 is a perspective view of the blowdown manifold and the scavenge manifold coupled to a flange for mounting on the engine;

FIG. 12 is a schematic illustration of the at least one actuator being further defined as a single actuator for selectively controlling the scavenge and blowdown valve members;

FIG. 13 is a schematic illustration of the first and second valve shafts being parallel to one another; and

FIG. 14 is a schematic illustration of the first and second valve members being co-axial with one another.

### DETAILED DESCRIPTION OF THE INVENTION

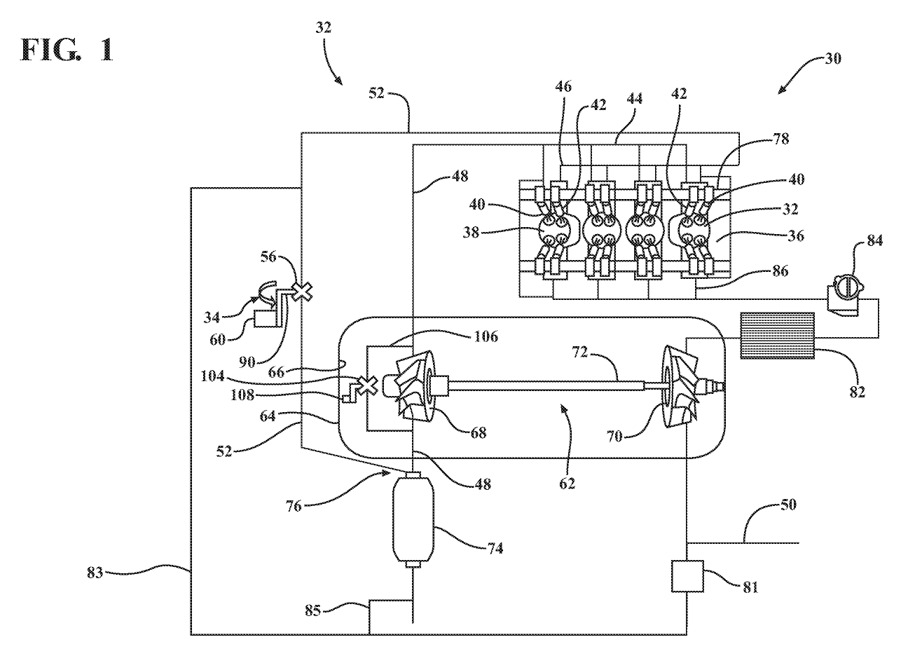

With reference to the Figures, wherein like numerals indicate like parts throughout the several views, a vehicle 30 including an assembly 32 is generally shown in FIG. 1. The assembly 32 includes valve system 34, as also shown in FIG. 1. The vehicle 30 includes an engine 36, which is schematically shown in FIG. 1. The engine 36 may include a plurality of cylinders 38, and a plurality of blowdown valves 40 and scavenge valves 42 coupled to the engine 36.

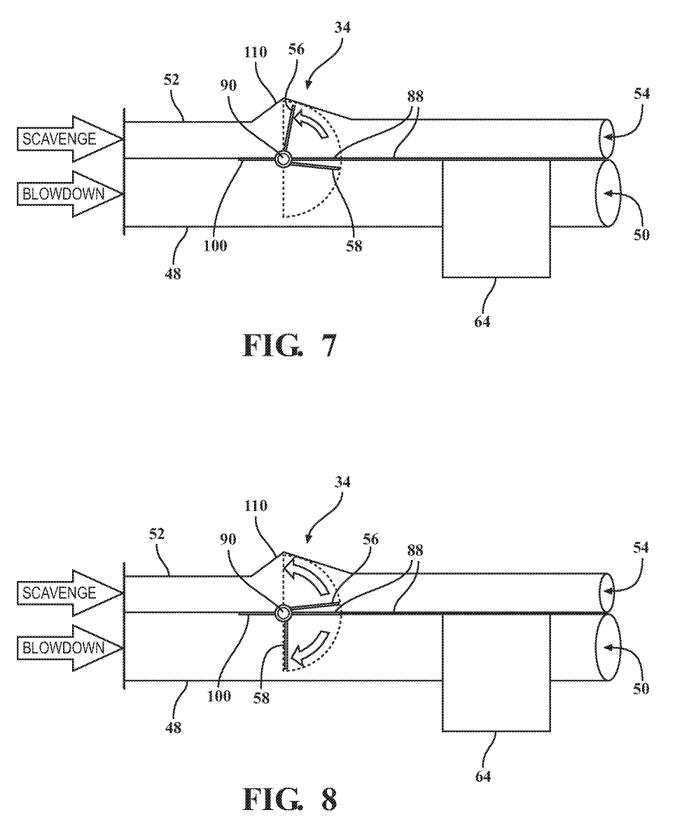

With continued reference to FIG. 1, the assembly 32 includes a blowdown manifold 44 adapted to be coupled to the engine 36 for receiving the exhaust gas from the engine 36, and a scavenge manifold 46 adapted to be coupled to the engine 36 for receiving the exhaust gas from the engine 36 independent from the blowdown manifold 44. Said differently, the exhaust gas emitted by the engine 36 is portioned into a flow of exhaust gas entering into the blowdown manifold 44 and a flow of exhaust gas entering into the scavenge manifold 46. Specifically, the scavenge manifold 46 may receive scavenge discharge exhaust gas from the plurality of cylinders 38, and the blowdown manifold 44 may receive blowdown exhaust gas from the plurality of cylinders 38. As best shown in FIG. 11, the blowdown manifold 44 and the scavenge manifold 46 may be coupled to a manifold flange 47 for mounting the blowdown manifold 44 and the scavenge manifold 46 to the engine 36.

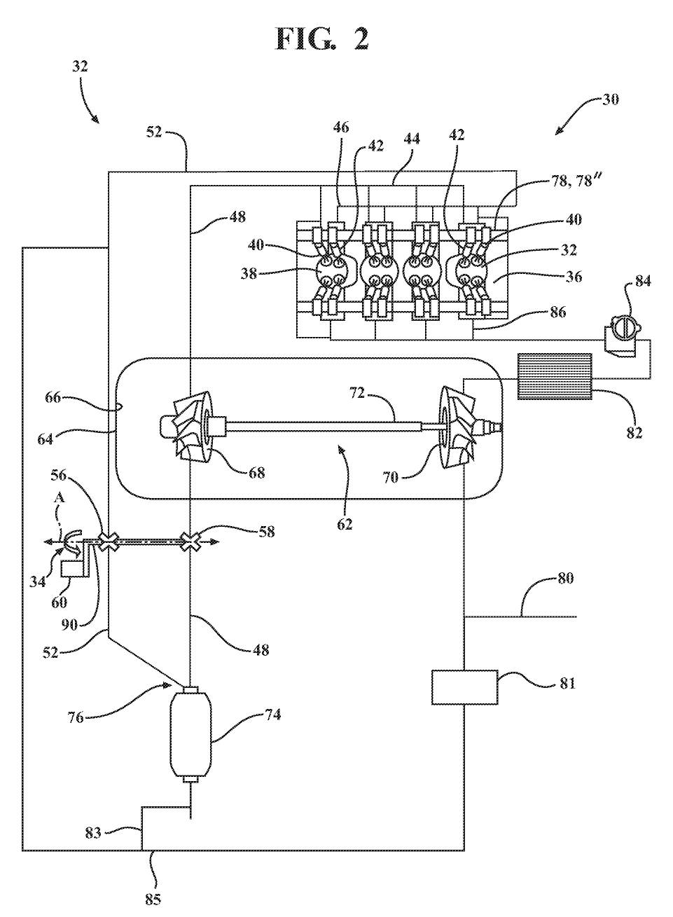

With reference to FIG. 1, the valve system 34 includes a blowdown pipe 48 adapted to be coupled to the blowdown manifold 44, with the blowdown pipe 48 defining a blowdown passage 50, as shown in FIG. 5, to receive the exhaust gas from the blowdown manifold 44. The valve system 34 also includes a scavenge pipe 52 adapted to be coupled to the scavenge manifold 46, with the scavenge pipe 52 defining a scavenge passage 54, as shown in FIG. 5, to receive the exhaust gas from the scavenge manifold 46. The valve system 34 additionally includes a scavenge valve member 56 coupled to the scavenge pipe 52 and disposed within the scavenge passage 54, with the scavenge valve member 56 being moveable to regulate the flow of the exhaust gas through the scavenge passage 54. The valve system 34 also includes at least one actuator 60 operably coupled to the scavenge valve member 56, with the at least one actuator 60 being adapted to selectively control movement of the scavenge valve member 56 to regulate the flow of the exhaust gas, as described in further detail below.

The assembly 32 also includes a turbocharger 62 coupled to the blowdown pipe 48, with the turbocharger 62 including a turbine housing 64 defining a turbine housing interior 66. The turbocharger 62 may include a turbine wheel 68 disposed within the turbine housing interior 66, and may include a compressor wheel 70 and a turbocharger shaft 72, with the turbine wheel 68 and the compressor wheel 70 rotatably coupled to one another by the turbocharger shaft 72. Typically, the turbocharger 62 and, specifically, the turbine housing 64 is coupled to the blowdown passage 50 for receiving the exhaust gas flowing through blowdown passage 50.

The assembly 32 may also include a pollution control device 74, such as a catalytic converter, for reducing toxins from the exhaust gas from being emitted into the atmosphere. The pollution control device 74 is coupled to the blowdown pipe 48 and the scavenge pipe 52 for receiving the exhaust gas from the engine 36. It is to be appreciated that the blowdown pipe 48 and the scavenge pipe 52 may direct the exhaust gas into the pollution control device 74 directly, or that the blowdown pipe 48 and the scavenge pipe 52 may converge into a single exhaust pipe 76 that is coupled to the pollution control device 74.

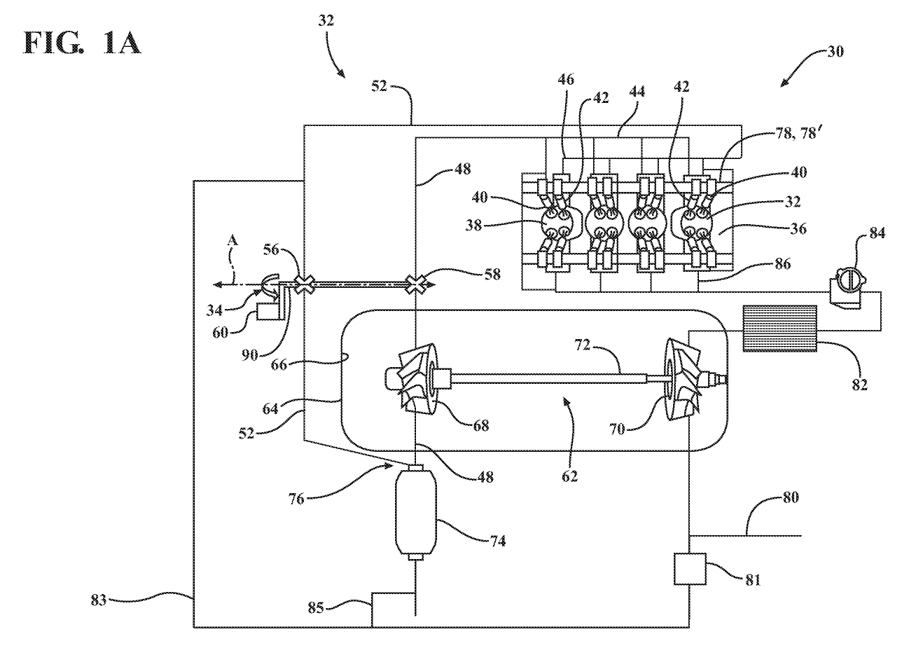

The vehicle 30 may include a cam/phaser 78 coupled to the engine 36. In one embodiment, the camshaft/phaser 78 is a concentric cam/phaser 78′, as indicated in FIG. 1, and in another embodiment is a non-concentric cam/phaser 78″, as indicated in FIG. 2. It is to be appreciated that the concentric cam/phaser 78′ indicated in FIG. 1 can also be used for the assembly 32 in FIG. 2, and the non-concentric cam/phaser 78″ indicated in FIG. 2 can also be used for the assembly 32 in FIG. 1.

The assembly 32 may include an air intake pipe 80 for supplying air to the compressor wheel 70 of the turbocharger 62, an air charged cooler 82 coupled to the air intake pipe 80 for receiving the air supplied through the air intake pipe 80, an intake throttle valve 84 coupled to the air intake pipe 80 for throttling the air delivered to the engine 36, and an intake manifold 86 coupled to the air intake pipe 80 for delivering air to the plurality of cylinders 38 of the engine 36.

The assembly 32 may include an EGR device 81 for receiving a portion of the exhaust gas downstream of the turbocharger 62 and the pollution control device 74 to further reduce toxins in the exhaust gas. The assembly 32 may include a high temperature EGR pipe 83 for directing exhaust gas from the scavenge pipe 52 to the EGR device 81. The assembly 32 may include a low temperature EGR pipe 85 for directing exhaust gas downstream of the pollution control device 74 to the EGR device 81.

The scavenge valve member 56 is disposed outside of the turbine housing interior 66. Having the scavenge valve member 56 disposed outside of the turbine housing interior 66 reduces the overall cost of design, manufacture, complexity, and the assembly of the valve system 34. Specifically, having the scavenge valve member 56 disposed outside of the turbine housing interior 66 allows for scavenge valve member 56 to be separate from the turbocharger 62, which allows for the scavenge valve member 56 to be designed without consideration of the various parts of the turbocharger 62. Additionally, having the scavenge valve member 56 disposed outside of the turbine housing interior 66 allows for quicker installation and disassembly of the scavenge valve member 56 because scavenge valve member 56 is not a part of the turbocharger 62. Furthermore, having scavenge valve member 56 disposed outside of the turbine housing interior 66 greatly reduces the complexity of the design of the turbocharger 62, as scavenge valve member 56 is not required to be a part of the turbocharger 62 and disposed within the turbine housing interior 66. Also, having scavenge valve member 56 disposed outside of the turbine housing interior 66 allows the scavenge valve member 56 to be designed to the scavenge pipe 52, which is easier and cheaper to design rather than designing scavenge valve member 56 as a component of the turbocharger 62. In other words, the scavenge valve member 56 may be directly engaged with the scavenge pipe 52 and may be disengaged from the turbine housing 64.

As described above, the scavenge valve member 56 is selectively controlled by the at least one actuator 60 and regulate the flow of exhaust gas through the scavenge pipe 52. Additionally, the scavenge valve member 56 may also regulate the flow of exhaust gas through both the scavenge pipe 52 and the blowdown pipe 48, as actuation of the scavenge valve member 56 can allow more exhaust gas to bypass the turbocharger 62 and flow directly to the pollution control device 74, or can restrict the exhaust gas from flowing through the scavenge pipe 52 and, therefore, increases the flow of the exhaust gas to the turbocharger 62. During a cold start, typically the scavenge valve member 56 allows the flow of exhaust gas to the pollution control device, and during increased performance demands the scavenge valve member 56 restricts the flow of exhaust gas through the scavenge pipe 52 to increase the flow of exhaust gas to the turbocharger 62. Additionally, a valve train (i.e., the cam/phasers described above) can also regulate the flow of exhaust gas into the scavenge pipe 52 and the blowdown pipe 48 to either direct more exhaust gas to the turbocharger 62 or the pollution control device 74.

The valve system 34 may include a blowdown valve member 58 coupled to the blowdown pipe 48 and disposed within the blowdown passage 54, with the blowdown valve member 58 being moveable to regulate the flow of the exhaust gas through the blowdown passage 50. Similarly, when both are present, the scavenge and blowdown valve members 56, 58 being disposed outside of the turbine housing interior 66 reduces the overall cost of design, manufacture, complexity, and the assembly of the valve system 34. Specifically, having the scavenge and blowdown valve members 56, 58 disposed outside of the turbine housing interior 66 allows for the scavenge and blowdown valve members 56, 58 to be separate from the turbocharger 62, which allows for the scavenge and blowdown valve members 56, 58 to be designed without consideration of the various parts of the turbocharger 62. Additionally, having the scavenge and blowdown valve members 56, 58 disposed outside of the turbine housing interior 66 allows for quicker installation and disassembly of the scavenge and blowdown valve members 56, 58 because the scavenge and blowdown valve members 56, 58 are not a part of the turbocharger 62. Furthermore, having the scavenge and blowdown valve members 56, 58 disposed outside of the turbine housing interior 66 greatly reduces the complexity of the design of the turbocharger 62, as the scavenge and blowdown valve members 56, 58 are not required to be a part of the turbocharger 62 and disposed within the turbine housing interior 66. Also, having the scavenge and blowdown valve members 56, 58 disposed outside of the turbine housing interior 66 allows the scavenge and blowdown valve members 56, 58 to be designed to the scavenge and blowdown pipes 52, 48, which is easier and cheaper to design rather than designing the scavenge and blowdown valve members 56, 58 as components of the turbocharger 62. In other words, the blowdown valve member 58 may be directly engaged with the blowdown pipe 52 and may be disengaged from the turbine housing 64.

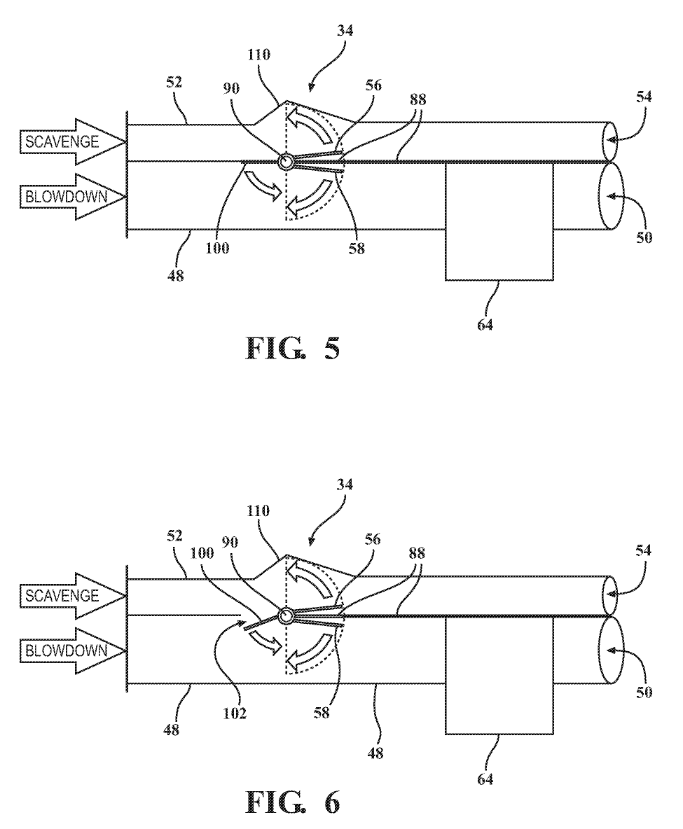

The scavenge and blowdown valve members 56, 58 may be configured as valve plates for controlling the flow of the exhaust gas through the blowdown and scavenge passages 50, 54, respectively. The scavenge and blowdown valve members 56, 58 may be configured as butterfly valves. The blowdown pipe 48 and the scavenge pipe 52 may share a common wall 88 separating the blowdown passage 50 from the scavenge passage 54, as best shown in FIGS. 5-11.

The scavenge and blowdown valve members 56, 58 may be moveable between a plurality of positions for controlling the flow of the exhaust gas. For example, the scavenge valve member 56 may have a first position for allowing the flow of the exhaust gas through the scavenge passage 54 where the scavenge passage 54 is fully open, at least 95% open, at least 90% open, at least 85% open, or at least 80% open, and the blowdown valve member 58 may have a first position where the blowdown passage 50 is fully open, at least 95% open, at least 90% open, at least 85% open, or at least 80% open. For further example, the scavenge valve member 56 may have a second position for restricting the flow of the exhaust gas through the scavenge passage 54 where the scavenge passage 54 is fully closed, at least 95% closed, at least 90% closed, at least 85% closed, or at least 80% closed, and the blowdown valve member 58 may have a second position for restricting the flow of the exhaust gas through the blowdown passage 58 where the blowdown 58 passage is fully closed, at least 95% closed, at least 90% closed, at least 85% closed, or at least 80% closed. In the fully closed position for both the scavenge valve member 56 and blowdown valve member 58, the scavenge valve member 56 and the blowdown valve member 58 may be perpendicular to the common wall 88.

In one embodiment, as shown in FIG. 1, the scavenge valve member 56 is adapted to be disposed downstream of the scavenge manifold 46 and upstream of the turbocharger 62. When present, the blowdown valve member 58 may be adapted to be disposed downstream of the blowdown manifold 44 and upstream of the turbocharger 62, as shown in FIGS. 1, 1A, 1B, 1C, 3, and 5-9. When the scavenge valve member 56 is disposed downstream of the scavenge manifold 46 and upstream of the turbocharger 62, and the blowdown valve member 58 is disposed downstream of the blowdown manifold 44 and upstream of the turbocharger 62, as described above, reduces the overall cost of design, manufacture, complexity, and the assembly of the valve system 34. Additionally, having the scavenge and blowdown valve members 56, 58 disposed upstream of the turbocharger 62 can reduce the overall size and weight of the scavenge and blowdown valve members 56, 58 as the flow area of the blowdown passage 50 and scavenge passage 54 upstream of the turbocharger 62 is less than the flow area of the blowdown passage 50 and the scavenge passage 54 downstream of the turbocharger 62.

In another embodiment, as shown in FIG. 2A, the scavenge valve member 56 is adapted to be disposed downstream of the scavenge manifold 46 and downstream of the turbocharger 62. When present, the blowdown valve member 58 may be adapted to be disposed downstream of the blowdown manifold 44 and downstream of the turbocharger 62, as shown in FIGS. 2, 4, and 10. In this embodiment, the scavenge and blowdown valve members 56, 58 may be mounted between a mounting flange of the turbine housing 64 and an inlet flange of the pollution control device 74. When the scavenge valve member 56 is disposed downstream of the scavenge manifold 46 and downstream of the turbocharger 62, and the blowdown valve member 58 is disposed downstream of the blowdown manifold 44 and downstream of the turbocharger 62, in addition to reducing the overall cost of design, manufacture, complexity, and the assembly of the valve system 34, also offers several advantages. First, having the scavenge and blowdown valve members 56, 58 disposed outside of the turbine housing interior 66, and downstream of the turbocharger 62 exposes the scavenge and blowdown valve members 56, 58 to lower exhaust gas temperatures than when the scavenge and blowdown valve members 56, 58 are upstream of the turbocharger 62. Additionally, having the scavenge and blowdown valve members 56, 58 disposed outside of the turbine housing interior 66, and downstream of the turbocharger 62 exposes the scavenge and blowdown valve members 56, 58 to lower exhaust gas pressures because the outlet pressure of the exhaust gas from the turbocharger 62 is less than the exhaust gas pressure entering into the turbocharger 62. Having the scavenge and blowdown valve members 56, 58 exposed to lower exhaust temperature and pressure can help increase the lifespan of the valve system, which ultimately reduces overall costs of the valve system. Furthermore, a flow disturbance of the exhaust gas is reduced, as the scavenge and blowdown valve members 56, 58 being downstream of the turbocharger 62 will not affect the performance of the turbine wheel 68 due to a pressure drop across the scavenge and blowdown valve members 56, 58 which may occur when the scavenge and blowdown valve members 56, 58 are disposed upstream from the turbocharger 62. Additionally, reducing or eliminating the pressure drop and/or disturbance of the exhaust gas upstream of the turbocharger 62 allows the turbocharger 62 to maximize energy obtained from the exhaust gas. Also, the volume of the blowdown passage 50 and the scavenge passage 54 may not have any effect on tuning of the turbine wheel 68 of the turbocharger 62.

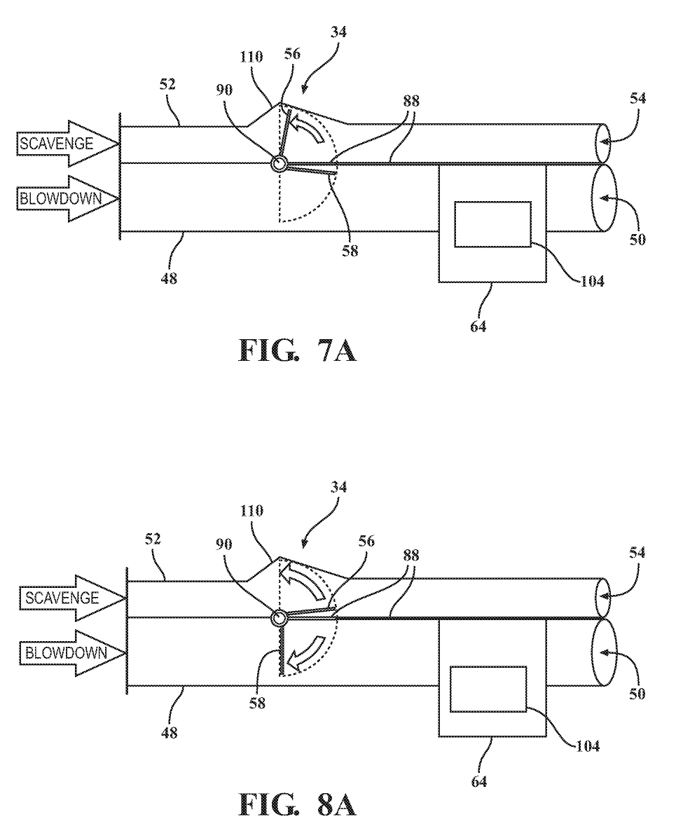

In one embodiment, the at least one actuator 60 is further defined as a single actuator, with the single actuator being adapted to selectively control movement of the scavenge and blowdown valve members 56, 58 to regulate the flow of the exhaust gas. When the at least one actuator 60 is further defined as the single actuator, the valve system 34 may include a valve shaft 90 operably coupled to the actuator and extending along an axis, with the scavenge valve member 56 and the blowdown valve member 58 being rotatable about the axis during actuation of the actuator such that the scavenge valve member 56 and the blowdown valve member 58 have a common axis of rotation, as best shown in FIGS. 1A, 2, 3, and 4. It is to be appreciated that the description of the scavenge and blowdown valve members 56, 58 moving below may be accomplished when the at least one actuator 60 is further defined as the single actuator. It is also to be appreciated that the valve shaft 90 may be provided with a number of lost motion mechanisms to control movement of the scavenge and blowdown valve members 56, 58. For example, as shown schematically in FIG. 12, the scavenge and blowdown valve members 56, 58 may be controlled by a single actuator through a lost motion mechanism 91.

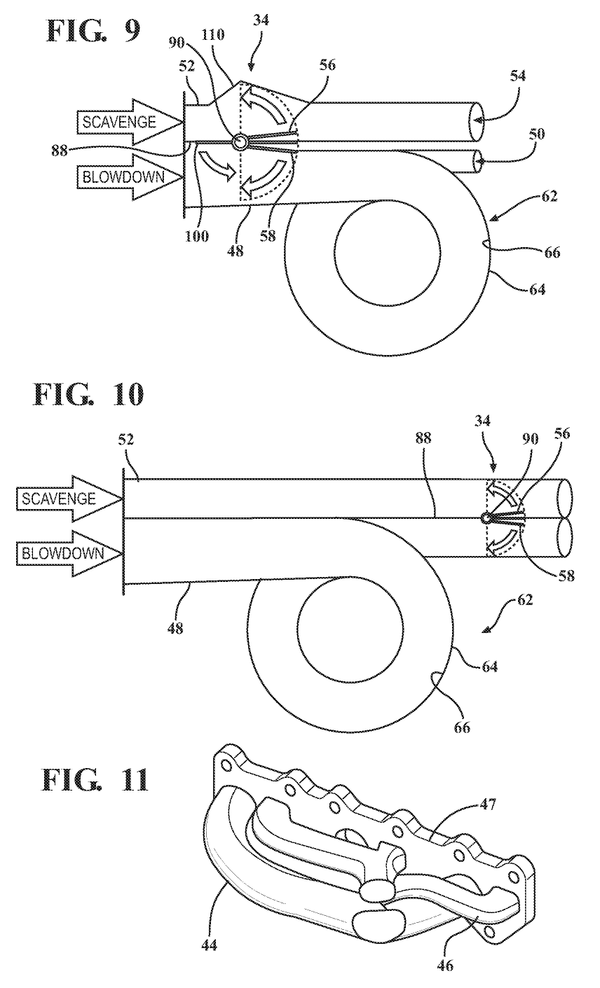

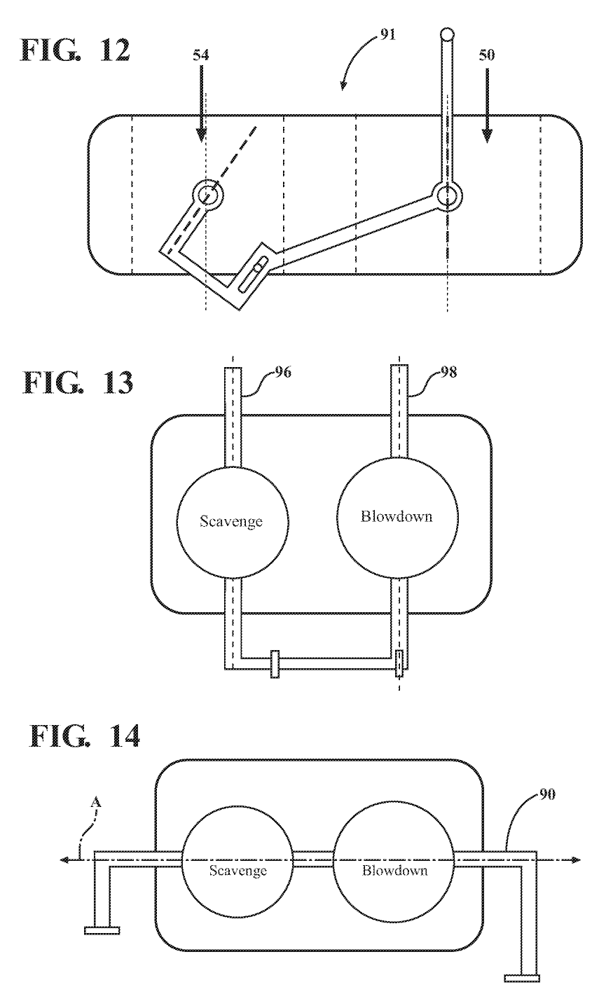

In other embodiments, as best shown in FIG. 1B, the at least one actuator 60 is further defined as a first actuator 92 and a second actuator 94, with the first actuator 92 being operably coupled to the scavenge valve member 56 to move the scavenge valve member 56 to regulate the flow of exhaust gas through the scavenge passage 54, and with the second actuator 94 being operably coupled to the blowdown valve member 58 to move the blowdown valve member 58 to regulate the flow of exhaust gas through the blowdown passage 50. In this embodiment, the valve system 34 may include a first valve shaft 96 extending along a first axis B and coupled to the scavenge valve member 56, and a second valve shaft 98 extending along a second axis C and coupled to the blowdown valve member 58, with the first and second valve shafts 96, 98 being parallel to one another. As shown in FIG. 13, the first and second valve shafts 96, 98 may be parallel to one another. As shown in FIG. 14, the valve shaft 90 may be coupled to the scavenge and blowdown valve members 56, 58 such that the scavenge and blowdown valve members 56, 58 are rotatable about a common axis (i.e., axis A). It is to be appreciated that the first and second valve shafts 96, 98 may be concentric shafts.

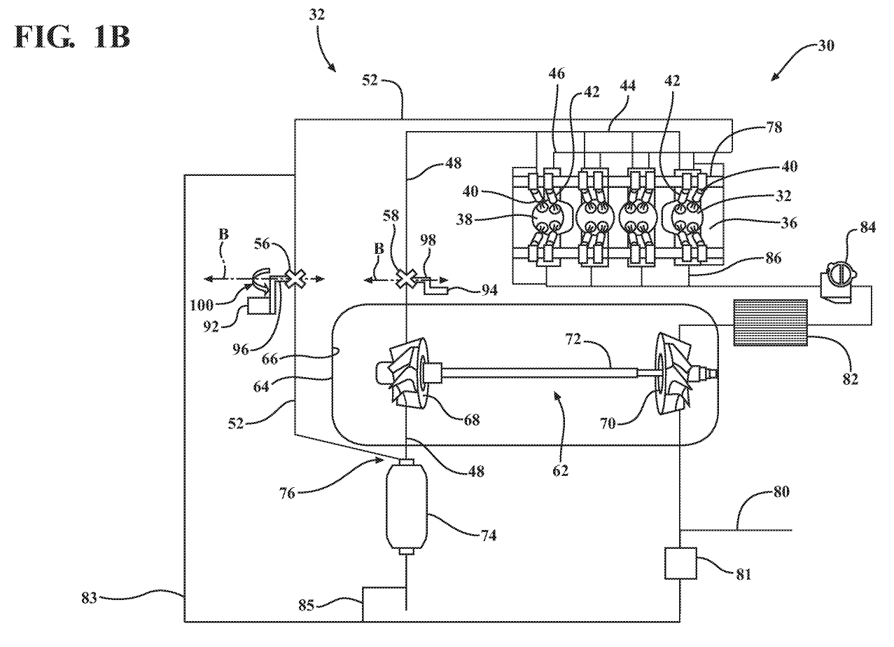

The valve system 34 may include a third valve member 100 operably coupled to the at least one actuator 60, and the common wall 88 may define a wastegate crossover passage 102 fluidly coupling the blowdown passage 50 and the scavenge passage 54, with the third valve member 100 being moveable by the at least one actuator 60 to regulate the flow of the exhaust gas between the blowdown passage 50 and the scavenge passage 54 through the wastegate crossover passage 102, as best shown in FIGS. 5-9. In one embodiment, the third valve member is configured as a valve plate. In another embodiment, the third valve member 100 is configured as a butterfly valve. In one embodiment, as shown in FIG. 3, the third valve member 100 is disposed downstream of the blowdown manifold 44 and the scavenge manifold 46, and is disposed upstream of the turbocharger 62.

The third valve member 100 may be moveable between a plurality of positions. For example, the third valve member 100 may have a first position for allowing the flow of the exhaust gas to flow between the blowdown passage 50 and the scavenge passage 54, and a second position for blocking the flow of the exhaust gas between the blowdown passage 50 and the scavenge passage 54. When the third valve member 100 is in the first position, the third valve member 100 may be parallel to the common wall 88, and when the third valve member 100 is in the second position, the third valve member 100 may be obliquely oriented with respect to the common wall 88. In one embodiment, as shown in FIGS. 3 and 5-9, the third valve member 100 is disposed outside of the turbine housing interior 66.

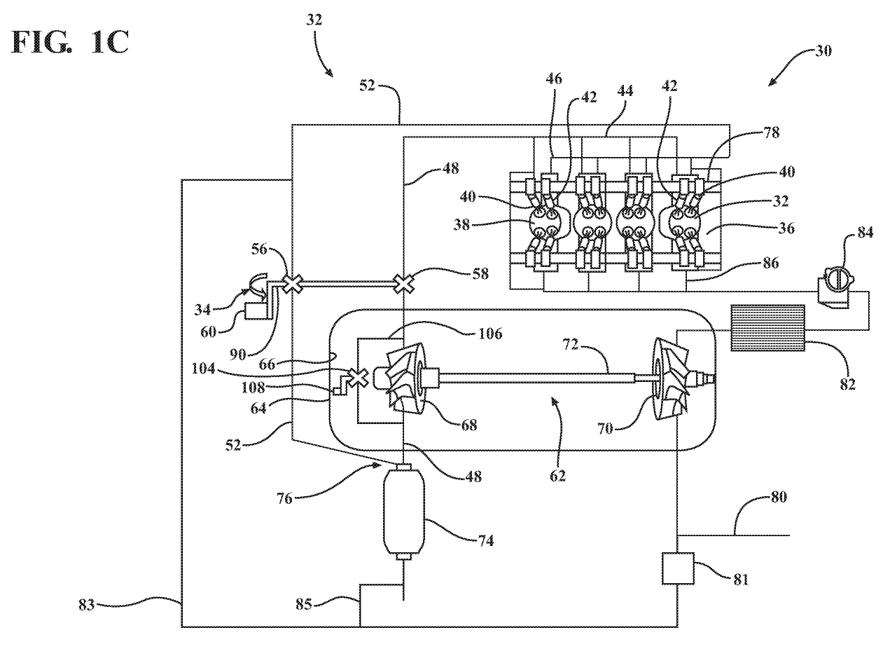

In another embodiment, as shown in FIG. 4, the turbocharger 62 may include a wastegate valve member 104, with the turbine housing 64 defining a turbine wastegate crossover passage 106 for diverting exhaust gas aware from the turbine wheel 68. In this embodiment, the turbocharger 62 may include a wastegate actuator 108 with the wastegate valve member 104 operably coupled to the wastegate actuator 108, with the wastegate actuator 108 being adapted to selectively control movement of the wastegate valve member 104 to divert the flow of the exhaust gas away from the turbine wheel 68.

As shown in FIG. 5, the scavenge valve member 56 and the blowdown valve member 58 are in each of the respective first positions and the third valve member 100 is in the second position, with the scavenge valve member 56 allowing the exhaust gas to flow through the scavenge passage 54, the blowdown valve member 58 allowing the exhaust gas to flow through the blowdown passage 50, and with the third valve member 100 blocking the flow of the exhaust gas between the blowdown passage 50 and the scavenge passage 54. In other embodiments, the valve system 34 shown in FIG. 5 may be without the third valve member 100 and/or the wastegate crossover passage 102, as shown in FIG. 5A. In such embodiments, the scavenge and blowdown valve members 56, 58 are present to selectively control the flow of the exhaust gas through the scavenge and blowdown passages 54, 50. The valve system 34 shown in FIGS. 5 and 5A may be referred to as being in the neutral position. Typically, when the valve system 34 is in the neutral position, engine boost supplied by the turbocharger 62 may be controlled by modulation of the cam/phaser 78.

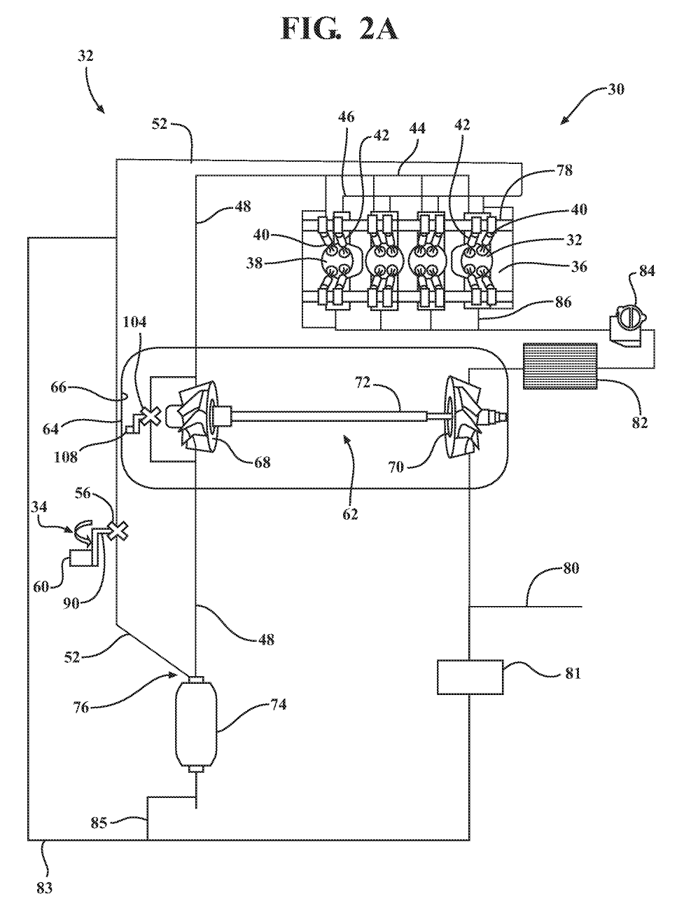

As shown in FIG. 6, the scavenge valve member 56, the blowdown valve member 58, and the third valve member 100 are in each of the respective first positions, with the scavenge valve member 56 allowing the exhaust gas to flow through the scavenge passage 54, the blowdown valve member 58 allowing the exhaust gas to flow through the blowdown passage 50, and with the third valve member 100 allowing the flow of the exhaust gas between the blowdown passage 50 and the scavenge passage 54. The valve system 34 shown in FIG. 6 may be in the vehicle 30 that does not have a concentric cam/phaser, i.e., a non-concentric cam phaser. The configuration of the scavenge, blowdown, and third valve members 56, 58, 100 in FIG. 6 shows an example of situations where the third valve member 100 is in the first position and may be used to control boost at moderate to high engine loads. Specifically, when the third valve member 100 is in the first position, the third valve member 100 allows the flow of exhaust gas to flow from the blowdown passage 50, through the wastegate crossover passage 102, and into the scavenge passage 54, which allows the exhaust gas to bypass the turbine wheel 68 of the turbocharger 62. When the third valve member 100 is in the first position, the blowdown valve member 58 may be in the first position for allowing the flow of the exhaust gas through the blowdown passage 50 to allow the exhaust gas to flow to the turbocharger 62 or may be in the second position for restricting the flow of exhaust gas to the turbocharger 62, and the scavenge valve member 56 may be in the first position to allow the flow of exhaust gas through the scavenge passage 54. In other embodiments, the valve system 34 shown in FIG. 6 may be without the third valve member 100 and/or the wastegate crossover passage 102, as shown in FIG. 6A.

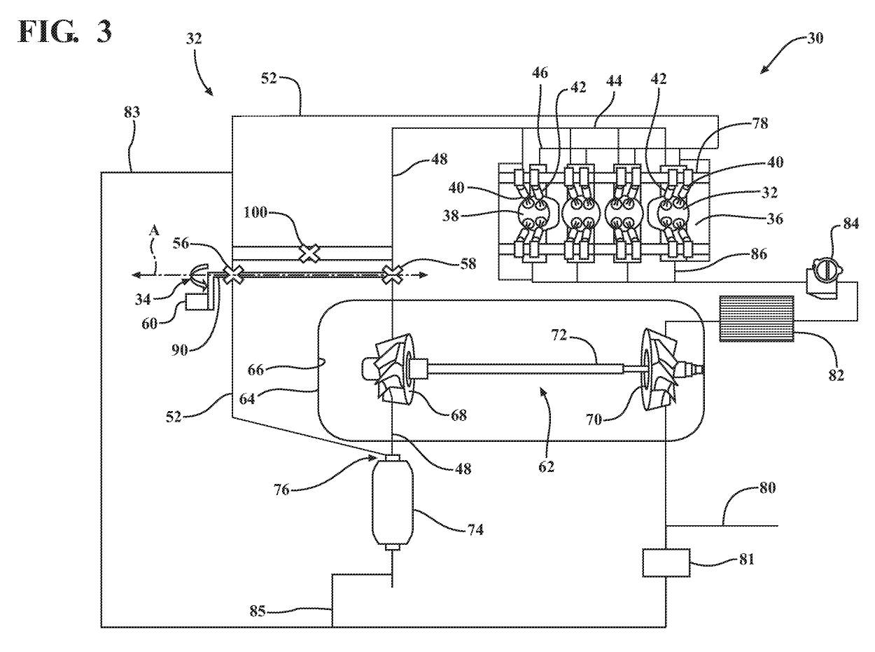

As shown in FIG. 7, the blowdown valve member 58 is in the first position, the scavenge valve member 56 is in the second position, and the third valve member 100 is in the second position, with the blowdown valve member 58 allowing the exhaust gas to flow through the blowdown passage 50, the scavenge valve member 56 restricting the flow of the exhaust gas through the scavenge passage 54, and with the third valve member 100 blocking the flow of the exhaust gas between the blowdown passage 50 and the scavenge passage 54. The configuration of the scavenge, blowdown, and third valve members 56, 58, 100 in FIG. 7 shows an example of situations where low-speed boost enhancement is needed for the engine 36. In such cases, the scavenge valve member 56 may be moved to the second position to at least partially restrict the flow of exhaust gas through the scavenge passage 54, which, in turn, allows more exhaust gas to flow through the blowdown passage 50 and to the turbocharger 62, thereby providing a boost to the engine 36 by the turbocharger 62. It is to be appreciated that the scavenge valve member 56 may be in the second position and may completely block the flow of the exhaust gas through the scavenge passage 54, or to a position which blocks 95% of the scavenge passage 54, 90% of the scavenge passage 54, 85% of the scavenge passage 54, or 80% of the scavenge passage 54. The blowdown valve member 58 may be in the first position such that the blowdown valve member 58 allows the flow of exhaust gas through the blowdown passage 50 and to the turbocharger 62. In other embodiments, the valve system 34 shown in FIG. 7 may be without the third valve member 100 and/or the wastegate crossover passage 102, as shown in FIG. 7A.

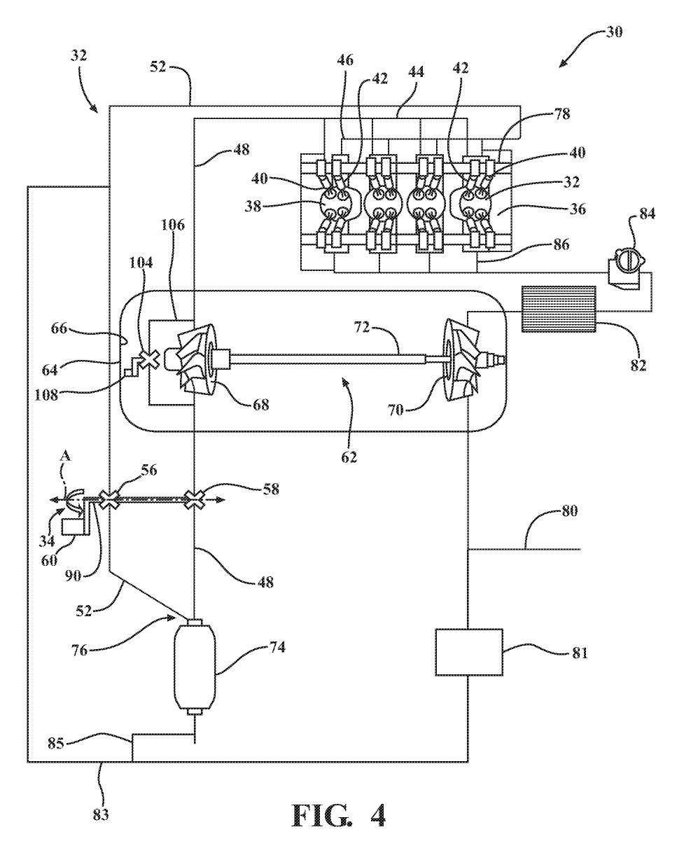

As shown in FIG. 8, the blowdown valve member 58 is in the second position, the scavenge valve member 56 is in the first position, and the third valve member 100 is in the second position, with the blowdown valve member 58 restricting the flow of the exhaust gas through the blowdown passage 50, the scavenge valve member 56 allowing the exhaust gas to flow through the scavenge passage 54, and with the third valve member 100 blocking the flow of the exhaust gas between the blowdown passage 50 and the scavenge passage 54. The configuration of the scavenge, blowdown, and third valve members 56, 58, 100 in FIG. 8 shows an example of situations where exhaust gas is directed to bypass the turbocharger 62, such as a cold start. During a cold start, the pollution control device 74, such as a catalytic converter, needs to be warmed up to the operating temperature in order to effectively reduce toxins in the exhaust gas. In such situations, the blowdown valve member 58 is moved to the second position to restrict the exhaust gas from flowing through the blowdown passage 50 and to the turbocharger 62. Rather than allowing the exhaust gas to flow through the blowdown passage 50 to the turbocharger 62, the exhaust gas in the blowdown passage 50 is directed through the wastegate crossover passage 102 and into the scavenge passage 54, where the scavenge valve member 56 is in the first position to allow the exhaust gas to flow through the scavenge passage 54 to quickly warm up the pollution control device 74, such as a catalytic converter, to the operating temperature. The third valve member 100, as shown in FIG. 8, may be in the second position to block the exhaust gas from flowing from the blowdown passage 50, through the wastegate crossover passage 102, and into the scavenge passage 54. Rather, when the third valve member 100 is in the second position and blocking the exhaust gas from flowing from the blowdown passage 50, through the wastegate crossover passage 102, and into the scavenge passage 54, and when the blowdown valve member 58 is in the second position to restrict the flow of exhaust gas through the blowdown passage 50, results in a maximum amount of exhaust gas to flow to the pollution control device 74, such as a catalytic converter, to quickly warm up the pollution control device 74 to the operating temperature. In other words, when the exhaust gas is blocked or restricted from flowing through the blowdown passage 50, all of the exhaust gas bypasses the turbocharger 62 and flows directly to the pollution control device 74, such as a catalytic converter, which is desirable during a cold start. In other embodiments, the valve system 34 shown in FIG. 8 may be without the third valve member 100 and/or the wastegate crossover passage 102, as shown in FIG. 8A.

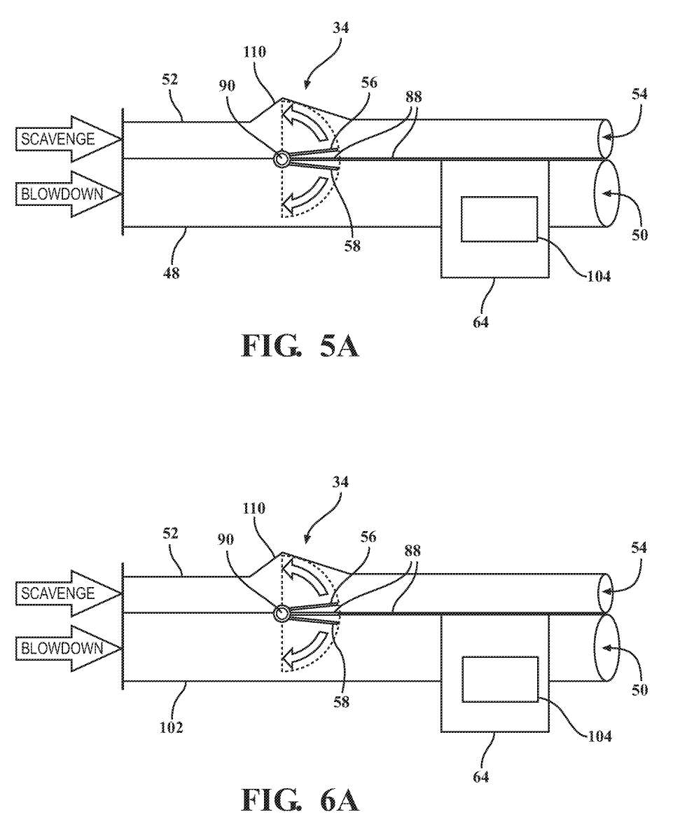

It is to be appreciated that the description of the control of the scavenge and blowdown valve members 56, 58 with respect to FIGS. 5-8 also applies to situations where the scavenge and blowdown valve members 56, 58, are disposed downstream of the turbocharger, as shown in FIG. 10. It is also to be appreciated that, as shown schematically in FIG. 4, that the wastegate valve member 104 may be disposed within the turbine housing interior 66, as described in detail above.

It is to be appreciated that the valve system 34 may include a valve housing 110 that is coupled to and receives the first and second valve members 56, 58 and, when present, the third valve member 100. In such embodiments, the valve housing 110 may be flanged to the blowdown pipe 48 and/or the scavenge pipe 52.

When the third valve member 100 and the valve shaft 90 are present and the at least one actuator 60 is further defined as a single actuator, the single actuator may be adapted to selectively control movement of the valve shaft 90, and the scavenge, blowdown, and third valve members 56, 58, 100 may be operably coupled to the valve shaft 90 and rotatable about the axis during actuation of the actuator such that the scavenge, blowdown, and third valve members 56, 58, 100 have a common axis of rotation.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. An assembly for controlling a flow of exhaust gas from an engine, said assembly comprising:
a blowdown manifold adapted to be coupled to the engine for receiving the exhaust gas from the engine;
a scavenge manifold adapted to be coupled to the engine for receiving the exhaust gas from the engine independent from said blowdown manifold;
a valve system comprising,
a blowdown pipe coupled to said blowdown manifold, with said blowdown pipe defining a blowdown passage to receive the exhaust gas from said blowdown manifold,
a scavenge pipe coupled to said scavenge manifold, with said scavenge pipe defining a scavenge passage to receive the exhaust gas from said scavenge manifold,
a scavenge valve member coupled to said scavenge pipe and disposed within said scavenge passage, with said scavenge valve member being moveable to regulate the flow of exhaust gas through said scavenge passage, and
at least one actuator operably coupled to said scavenge valve member, with said at least one actuator being adapted to selectively control movement of said scavenge valve member to regulate the flow of exhaust gas; and
a turbocharger coupled to said blowdown scavenge pipe, with said turbocharger comprising a turbine housing defining a turbine housing interior, and a turbine wheel disposed within the turbine housing interior;
wherein said scavenge valve member of said valve system is disposed outside of said turbine housing interior.

2. The assembly as set forth in claim 1, wherein said valve system further comprises a blowdown valve member coupled to said blowdown pipe and disposed within said blowdown passage, with said blowdown valve member being moveable to regulate the flow of exhaust gas through said blowdown passage, with said blowdown valve member being disposed outside of said turbine housing interior, and with said at least one actuator being adapted to selectively control movement of said blowdown valve member to regulate the flow of exhaust gas.

3. The assembly as set forth in claim 2, wherein said scavenge valve member is disposed downstream of said scavenge manifold and upstream of said turbocharger, and wherein said blowdown valve member is disposed downstream of said blowdown manifold and upstream of said turbocharger.

4. The assembly as set forth in claim 2, wherein said scavenge valve member is disposed downstream of said scavenge manifold and downstream of said turbocharger, and wherein said blowdown valve member is disposed downstream of said blowdown manifold and downstream of said turbocharger.

5. The assembly as set forth in claim 2, wherein said at least one actuator is further defined as a first actuator and a second actuator, with said first actuator being operably coupled to said scavenge valve member to move said scavenge valve member to regulate the flow of exhaust gas through said scavenge passage, and with said second actuator being operably coupled to said blowdown valve member to move said blowdown valve member to regulate the flow of exhaust gas through said blowdown passage.

6. The assembly as set forth in claim 1, wherein said turbine housing of said turbocharger defines a turbine wastegate crossover passage for diverting the exhaust gas away from said turbine wheel; and
wherein said turbocharger further comprises a wastegate actuator and a wastegate valve member operably coupled to said wastegate actuator, with said wastegate actuator being adapted to selectively control movement of said wastegate valve member to divert the flow of the exhaust gas away from said turbine wheel.

7. The assembly as set forth in claim 1, wherein said scavenge valve member is disposed downstream of said scavenge manifold and upstream of said turbocharger.

8. The assembly as set forth in claim 1, wherein said scavenge valve member is disposed downstream of said scavenge manifold and downstream of said turbocharger.

9. The assembly as set forth in claim 1, wherein said turbine housing of said turbocharger defines a turbine wastegate crossover passage for diverting the exhaust gas away from said turbine wheel, and wherein said turbocharger further comprises a wastegate actuator and a wastegate valve member operably coupled to said wastegate actuator, with said wastegate actuator being adapted to selectively control movement of said wastegate valve member to divert the flow of the exhaust gas away from said turbine wheel.

10. A valve system for controlling a flow of exhaust gas from an engine of a vehicle, with the vehicle including an assembly including a turbocharger, with the turbocharger including a turbine housing defining a turbine housing interior, said valve system comprising:
a blowdown pipe adapted to be coupled to a blowdown manifold, with said blowdown pipe defining a blowdown passage adapted to receive the exhaust gas from the blowdown manifold and the engine;
a scavenge pipe adapted to be coupled to a scavenge manifold, with said scavenge pipe defining a scavenge passage adapted to receive the exhaust gas from the scavenge manifold and the engine independent from said blowdown passage;
a scavenge valve member coupled to said scavenge pipe and disposed within said scavenge passage, with said scavenge valve member being moveable to regulate the flow of exhaust gas through said scavenge passage; and
at least one actuator operably coupled to said scavenge valve member, with said at least one actuator being adapted to selectively control movement of said scavenge valve member to regulate the flow of exhaust gas;
wherein said first valve member is adapted to be disposed outside of the turbine housing interior.

11. The valve system as set forth in claim 10, further comprising a blowdown valve member coupled to said blowdown pipe and disposed within said blowdown passage, with said blowdown valve member being moveable to regulate the flow of exhaust gas through said blowdown passage, with said blowdown valve member being adapted to be disposed outside of the turbine housing interior, and with said at least one actuator being adapted to selectively control movement of said blowdown valve member to regulate the flow of exhaust gas.

12. The valve system as set forth in claim 11, wherein said scavenge valve member is adapted to be disposed downstream of said scavenge manifold and upstream of the turbocharger, and wherein said blowdown valve member is adapted to be disposed downstream of said blowdown manifold and upstream of the turbocharger.

13. The valve system as set forth in claim 11, wherein said scavenge valve member is adapted to be disposed downstream of the scavenge manifold and downstream of the turbocharger, and wherein said blowdown valve member is adapted to be disposed downstream of said blowdown manifold and downstream of the turbocharger.

14. The valve system as set forth in claim 11, further comprising a valve shaft extending along an axis, wherein said at least one actuator is further defined as a single actuator with said valve shaft being operably coupled to said actuator, and wherein scavenge valve member and said blowdown valve member are rotatable about said axis during actuation of said single actuator such that said scavenge valve member and said blowdown valve member have a common axis of rotation.

15. The valve system as set forth in claim 11, wherein said at least one actuator is further defined as a first actuator and a second actuator, with said first actuator being operably coupled to said scavenge valve member to move said scavenge valve member to regulate the flow of exhaust gas through said scavenge passage, and with said second actuator being operably coupled to said blowdown valve member to move said blowdown valve member to regulate the flow of exhaust gas through said blowdown passage.

16. The valve system as set forth in claim 11, wherein said blowdown pipe and said scavenge pipe share a common wall separating said blowdown passage from said scavenge passage, and further comprising a third valve member operably coupled to said at least one actuator, and wherein said common wall defines a wastegate crossover passage fluidly coupling said blowdown passage and said scavenge passage, with said third valve member being moveable by said at least one actuator to regulate the flow of the exhaust gas between said blowdown passage and said scavenge passage through said wastegate crossover passage.

17. The valve system as set forth in claim 16, further comprising a valve shaft extending along an axis and operably coupled to said actuator, wherein said at least one actuator is further defined as a single actuator, with said single actuator being adapted to selectively control movement of said valve shaft, and wherein said scavenge, blowdown, and third valve members are operably coupled to said valve shaft and rotatable about said axis during actuation of said actuator such that said scavenge, blowdown, and third valve members have a common axis of rotation.

18. The valve system as set forth in claim 10, wherein said scavenge valve member is disposed downstream of said scavenge manifold and adapted to be disposed upstream of the turbocharger.

19. The valve system as set forth in claim 10, wherein said scavenge valve member is disposed downstream of said scavenge manifold and adapted to be disposed downstream of the turbocharger.

20. A vehicle comprising:
an engine; and
an assembly for controlling exhaust gas from said engine, said assembly comprising,
a blowdown manifold coupled to the engine for receiving the exhaust gas from said engine;
a scavenge manifold coupled to the engine for receiving the exhaust gas from said engine independent from said blowdown manifold;
a valve system comprising,
a blowdown pipe coupled to said blowdown manifold, with said blowdown pipe defining a blowdown passage to receive the exhaust gas from said blowdown manifold,
a scavenge pipe coupled to said scavenge manifold, with said scavenge pipe defining a scavenge passage to receive the exhaust gas from said scavenge manifold,
a scavenge valve member coupled to said scavenge pipe and disposed within said scavenge passage, with said scavenge valve member being moveable to regulate the flow of exhaust gas through said scavenge passage, and
at least one actuator operably coupled to said scavenge valve member, with said at least one actuator being adapted to selectively control movement of said scavenge valve member to regulate the flow of exhaust gas; and
a turbocharger coupled to said blowdown pipe, with said turbocharger comprising a turbine housing defining a turbine housing interior, and a turbine wheel disposed within the turbine housing interior;
wherein said scavenge valve member is disposed outside of said turbine housing interior.

21. The vehicle as set forth in claim 20, wherein said valve system further comprises a blowdown valve member coupled to said blowdown pipe and disposed within said blowdown passage, with said blowdown valve member being moveable to regulate the flow of exhaust gas through said blowdown passage, with said blowdown valve member being disposed outside of said turbine housing interior, and with said at least one actuator being adapted to selectively control movement of said blowdown valve member to regulate the flow of exhaust gas.

22. The vehicle as set forth in claim 20, wherein said turbine housing of said turbocharger defines a turbine wastegate crossover passage for diverting the exhaust gas away from said turbine wheel, and wherein said turbocharger further comprises a wastegate actuator, a wastegate valve member operably coupled to said wastegate actuator, with said wastegate actuator being adapted to selectively control movement of said wastegate valve member to divert the flow of the exhaust gas away from said turbine wheel.
